(19) United States
(12) Patent Application Publication
(10) Pub. No.: US 2025/0209308 A1
(43) Pub. Date: Jun. 26, 2025

(54) Risk Analysis and Visualization for Sequence Processing Models

(71) Applicant: Google LLC, Mountain View, CA (US)

(72) Inventors: Assaf Namer, Sunnyvale, CA (US); Brandon Maltzman, Chicago, IL (US); James Scott Miller, West Hartford, CT (US); Tanay Narendra Buddhdev, Sunnyvale, CA (US)

(21) Appl. No.: 18/394,480

(22) Filed: Dec. 22, 2023

(51) Int. Cl. G06N 3/0455; G06F 16/953; G06N 3/0475

(52) U.S. Cl. CPC G06N 3/0455; G06F 16/953; G06N 3/0475

(57) ABSTRACT

Aspects of the disclosed technology include computer-implemented systems and methods for moderating generative content produced by machine-learned generative models and providing outputs indicative of query and response validity for a target domain. The system can generate a query association based on a user query and domain artifacts of a target domain and generate a response association based on generative content and the domain artifacts. The system can embed the domain artifacts in a vector embedding space and/or train a machine-learned model using the domain artifacts. The system can determine the validity of queries and responses for the target domain using the vector embeddings and the machine-learned model. The system can moderate content, such as by filtering queries and/or generative content that does not satisfy association criteria for a target domain. The system can generate outputs such as visualizations of query and response distance relative to a target domain.

### FIELD

The present disclosure relates generally to machine learning processes and machine-learned devices and systems. More particularly, the present disclosure relates to generative models, such as sequence processing models, and risk analysis of such models.

### BACKGROUND

Artificial intelligence systems increasingly include large foundational machine-learned models which have the capability to provide a wide range of new product experiences. As an example, machine-learned generative models have proven successful at generating and/or editing content such as text, images, audio, and/or videos. As these generative models have become more prevalent, so has the need to understand the content generated by these models. For instance, standards and protocols have been proposed to assess the artificial intelligence (AI) lifecycle of systems including their design, development, testing, deployment, monitoring, and more. Techniques exist for measuring the accuracy of some models, such as large language models (LLMs) or other sequence processing models. For instance, a word error rate can be calculated for a large language model. While these techniques can improve model performance and detect anomalies, they do not provide measurements or visualizations of model objectives such as justification and explanation.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by one or more processors. The method includes obtaining a user query requesting content generation by a machine-learned generative model, producing generative content based on processing the user query with the machine-learned generative model, generating data indicative of a query association with a target domain based on the user query and a plurality of domain artifacts associated with the target domain, generating data indicative of a response association with the target domain based on the generative content and the plurality of domain artifacts associated with the target domain, and generating a response to the user query based at least in part on the data indicative of the query association with the target domain and the data indicative of the response association with the target domain.

Another example aspect of the present disclosure is directed to a computing system including one or more processors, and one or more non-transitory computer-readable storage media that collectively store a machine-learned generative model configured to produce generative content in response to a user query, and instructions that, when executed by the one or more processors, cause the one or more processors to perform operations that include obtaining the generative content produced in response to the user query, determining a query association with a target domain based on the user query and a plurality of domain artifacts associated with the target domain, determining a response association with the target domain based on the generative content and the plurality of domain artifacts associated with the target domain, and generating a response to the user query based at least in part on the query association with the target domain and the response association with the target domain.

Another example aspect of the present disclosure is directed to one or more non-transitory computer-readable storage media that store instructions that, when executed by one or more processors, cause the one or more processors to perform operations including obtaining a user query requesting content generation by a machine-learned generative model, producing generative content based on processing the user query with the machine-learned generative model, generating data indicative of a query association with a target domain based on the user query and a plurality of domain artifacts associated with the target domain, generating data indicative of a response association with the target domain based on the generative content and the plurality of domain artifacts associated with the target domain, and generating one or more outputs including an indication of the query association and an indication of the response association.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a machine-learned generative model and controller according to example embodiments of the present disclosure;

FIG. 2 is a block diagram depicting an example computing environment and data flow for processing a user query according to example embodiments of the present disclosure;

FIG. 3 is a block diagram depicting an example computing environment and domain artifact processing according to example embodiments of the present disclosure;

FIG. 4 depicts an example visualization of query association and response association with a target domain and related domains according to example embodiments of the present disclosure;

FIG. 5 is a flowchart diagram depicting an example method of moderating a user query and generative content from a machine-learned generative model according to example embodiments of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example embodiments of the present disclosure;

FIG. 8 is a block diagram of an example sequence processing model according to example embodiments of the present disclosure;

FIG. 9 is a block diagram of an example technique for populating an example input sequence for processing by a sequence processing model according to example embodiments of the present disclosure;

FIG. 10 is a block diagram of an example model development platform according to example embodiments of the present disclosure;

FIG. 11 is a block diagram of an example training workflow for training a machine-learned model according to example embodiments of the present disclosure;

FIG. 12 is a block diagram of an inference system for operating one or more machine-learned model(s) to perform inference according to example embodiments of the present disclosure;

FIG. 13 is a block diagram of an example networked computing system according to example embodiments of the present disclosure;

FIG. 14 is a block diagram of an example computing device according to example embodiments of the present disclosure; and

FIG. 15 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learning systems and methods, and more particularly, to systems and methods for analyzing machine-learned models and evaluating model inputs (e.g., prompts) and model outputs (e.g., generative content) relative to one or more target domains. A machine-learning system can receive a user query, such as a prompt for a generative model and produce generative content based on the user query. The system can analyze queries, such as prompts and their corresponding responses from the generative model(s) to determine whether the query and response are valid for a target content domain. For example, a controller can determine whether the query and response are contextually relevant to the target domain. In this manner, the system can evaluate the applicability and risk of prompts issued to models, as well as the model's response to these prompts. Prompts and outputs that are further from a target domain can indicate a higher risk that a user is attempting to manipulate the system or otherwise use it in an unintended manner.

In accordance with example embodiments of the disclosed technology, the machine-learning system can include a controller that is configured to generate outputs indicative of the validity of queries and generative model responses for a target content domain. The system can measure input and output data in relation to a specified domain and then moderate responses or take other action(s) based on whether the query and/or response are valid for the target domain. For example, the controller can filter (e.g., block) or otherwise cause the system not to provide generative content that is not valid for one or more target domains. In some examples, an entity, such as a company or other organization, can use measurements of queries and model outputs to moderate responses including generative content based on the output of the controller indicating whether the query/response pair is valid for the target domain.

Additionally or alternatively, the controller can aggregate the results of processing a query and response to determine validity for a target domain. The aggregated data can be used to provide one more visualizations or other outputs illustrating the model performance relative to one or more target domains. The controller can generate one or more visualizations indicating the validity of the query and/or response for the target domain. By way of example, the controller can generate outputs indicating a distance (e.g., semantic distance) of the query and/or response from a target domain. For example, a visualization can be generated that illustrates the distance of the query and/or response from a target domain. The visualization can further illustrate the distance between the query and/or response and closely related domains to enhance the comparative aspects of the system.

In accordance with example implementations, the distance between model inputs/outputs and the target domain can be used to indicate skew or other deviation from the model's training data and/or the normal data served by the system. For example, a larger semantic distance between a model's input and/or output and training data may indicate a higher probability that the input and/or output is invalid for the target domain. Similarly, a larger distance between query embeddings and domain artifact embeddings may indicate a higher probability that an input or output is invalid for the target domain.

In accordance with example embodiments of the present disclosure, the system can utilize domain artifacts associated with one or more target domains to determine a query association and a response association with the target domain. The machine-learning system can use the query association and/or the response association as part of content moderation for the generative model and/or to generate visualizations of the model's performance relative to the target domain.

According to an example implementation of the disclosed technology, the machine-learning system can determine a query association by embedding a user query into a vector embedding space and determining one or more query distances based on a distance between the query embedding and embeddings of domain artifacts in the vector embedding space. Additionally or alternatively, the system can pass the user query to a machine-learned classification model that is trained on domain data (e.g., the domain artifacts and/or dataset) to determine a classification indicating whether the user query is associated with the target domain. In some examples, the system can generate a query association score for a target domain based on the distance between the query embedding and domain artifact embeddings and/or the classification generated by the classification model.

Similarly, the system can determine the response association by embedding the generative content produced by the generative model into the vector embedding space and determining one or more response distances based on a distance between the generative content embedding and embeddings of the domain artifacts in the vector embedding space. Additionally or alternatively, the system can pass the generative content to the machine-learned classification model to determine a classification indicating whether the generative content is associated with the target domain. In some examples, the system can generate a response association score for a target domain based on the distance between the response embedding and domain artifact embeddings and/or the classification generated by the classification model.

In accordance with an example implementation, the system can generate a response to the user query based, at least, in part, on the query association with the target domain and the response association with the target domain. For instance, the host computing system can include a controller that implements policies to filter queries and/or content that does not meet one or more association criteria which can include query association criteria and/or response association criteria. The policies can be established by a downstream entity utilizing the model. The system can compare the query association and the response association with the association criteria and, if the association criteria are not satisfied, the system can filter the generative content from the response to the user query. In example embodiments, the system can aggregate the query association results and the response association results to determine a response to the user query.

In accordance with example implementations of the present disclosure, the machine-learning system can generate and provide one or more visualizations associated with queries and responses generated by the generative model. For example, the system can aggregate the data associated with one or more query and response pairs to generate a visualization of the generative model's performance relative to one or more target domains. The system can access query association data for a set of queries issued to the generative model and data for a set of responses received in response to the set of queries. The system can generate aggregated results by combining the data for the query association and the response association for each query and response pair. The system can generate one or more outputs such as visualizations of the aggregated query association data and the aggregated response association data relative to one or more domains including a target domain.

Systems and methods in accordance with example embodiments of the present disclosure provide a number of technical effects and benefits. In particular, the systems and methods can include technologies for moderating generative content produced by generative models and producing visualizations of model processing relative to one or more target domains. The systems and methods introduce query association processing and response association processing to determine the validity of queries and responses for a target domain.

The introduction of query and response association processing into a content moderation system for machine-learned generative models provides a deeper understanding of the user queries provided to the system and the generative content produced in response to the queries. As such, more accurate moderation of content can be provided. Moreover, association processing enables the system to provide information, such as visualizations or other representations, that illustrates the distance between the model processing and the target domain(s) associated with a particular entity or enterprise. In turn, the accurate moderation and visualization of query and response association with a target domain can enable more efficient computing and usage of resources. For example, by measuring the validity of an input query against vector embeddings associated with a target domain and/or using a custom machine-learned model (e.g., an LLM), requests can be blocked before reaching a more resource-intensive model (e.g., another LLM), thus enabling efficient usage of compute resources, and thereby providing associated cost savings. Entities can ensure that models are used for their intended purposes and avoid processing for invalid queries and responses. Additionally, these techniques can also reduce risks of generating/supplying harmful content and can prevent certain types of attacks, such as model denial of service (MDOS) attacks, that reduce usability. In accordance with example embodiments of the disclosed technology, a machine-learning system can provide accurate determinations of query (e.g., prompt) and generative content validity for a particular domain. The system can provide outputs that indicate the validity of aggregated query and responses so that enterprises can assess the usage of generative models with respect to one or more target domains of the enterprise. In this manner, the systems and methods of the disclosed technology can enable measurements of relevance, suitability, and validity of prompts and responses to machine-learned generative models. By way of example and not limitation, such insights can further be used to fine tune a generative model to be more efficient with respect to a target domain. For instance, if requests are focused on a narrower target domain, some parameters of the model could be dropped. As another example, the insights can be used to educate users on what is and isn't allowed for querying with policies, procedures, or technical controls.

Aspects of the disclosed technology utilize domain artifacts to generate data for a vector embedding database that can be used to determine a distance of queries and responses to a target domain. Domain artifacts can be embedded into a vector embedding space and the vector embeddings stored in the vector embedding database. Prompts and generative content produced by the generative models can be embedded into the vector embedding space and compared with the domain artifact embeddings to efficiently determine a distance of the prompts and content from the target domain based on the embedding distances. The utilization of vector embeddings enables a comprehensive and efficient technique for measuring domain validity.

According to example aspects of the disclosed technology, domain artifacts are used to train a domain-specific model, such as a classification model that can be used to classify queries and responses as valid to a target domain. Domain artifacts can be used as training data to train the domain-specific model. In some examples, only target domain data is used to train the model. Prompts and generative content produced by the generative models can be provided as inputs to the classification model which can efficiently generate classifications indicating whether or not prompts and responses are valid for the target domain. A custom-trained, domain-specific model further enables a comprehensive and efficient technique for measuring input and output validity. This technique enables fine-grained domain definition.

In example implementations, the generative models can include sequence processing models, such as large language models (LLM). Much of the following disclosure refers to large language models as specific examples of generative models but it will be appreciated that the disclosure is equally applicable to any type of generative model such as other sequence processing models. For example, the disclosed technology can be used with large image models, multimodal models, and other types of foundational models. For instance, the generative models can operate in domains other than the text domain, such as image domains, audio domains, biochemical domains, etc. For instance, a sequence processing model may be used to process sequential inputs for robotic controls and other tasks. Similarly, the generative model and/or the downstream applications can be configured to perform any number of tasks. For instance, if the inputs to the generative model and/or a downstream application are images or features that have been extracted from images, the output generated by the generative model for a given image can be scores for each of a set of object categories, with each score representing an estimated likelihood that the image contains an image of an object belonging to the category. As another example, if the inputs to the generative model and/or a downstream application are sensor data, the outputs can be robotic control signals. The system can analyze the distance of generated signals relative to a target domain (e.g., using intended signals) to determine the validity of the generated signals.

As another example, if the input to the generative model is a sequence representing a spoken utterance, the output generated can be a score for each of a set of pieces of text, each score representing an estimated likelihood that the piece of text is the correct transcript for the utterance.

As another example, if the input to the generative model is a sequence of physiological measurements, the output generated may be a score for each of a set of possible diagnoses for the condition of a user, with the score representing an estimated likelihood that the diagnosis is accurate. In example embodiments, the controller can assess whether the physiological measurements are relevant to a particular domain (e.g., a diagnosis). In such a case, the system could detect whether the physiological measurements match a particular diagnosis associated with the measurements.

As another example, if the input to the generative model is a sequence of text from a received communication, the output generated may be a score for each of a set of possible responses to the received communication, with the score representing an estimated likelihood that the response matches a user's intent.

As another example, if the input to the generative model is indicative of a particular function to be performed by an apparatus (such as a robot), the output generated may be a score for each of a set of possible control signals for controlling the apparatus, with the score representing an estimated likelihood that the control signals match the particular function to be performed.

As another example, if the input to the generative model includes natural language indicative of a computer implemented operation, the output generated may be a score for each of a set of possible computer-readable code segments, with the score representing an estimated likelihood that the computer-readable code segments match the computer implemented operation.

As another example, if the input to the generative model is a sequence of text in one language, the output generated may be a score for each of a set of pieces of text in another language, with each score representing an estimated likelihood that the piece of text in the other language is a proper translation of the input text into the other language.

Although a number of examples of tasks which may be performed by the generative model and/or a downstream application are provided here, it will be understood that this is not exhaustive, and that the generative model and/or the downstream applications can be configured to perform any suitable task.

With reference now to the Figures, example embodiments of the present disclosure will be discussed in further detail.

### Example Model Arrangements

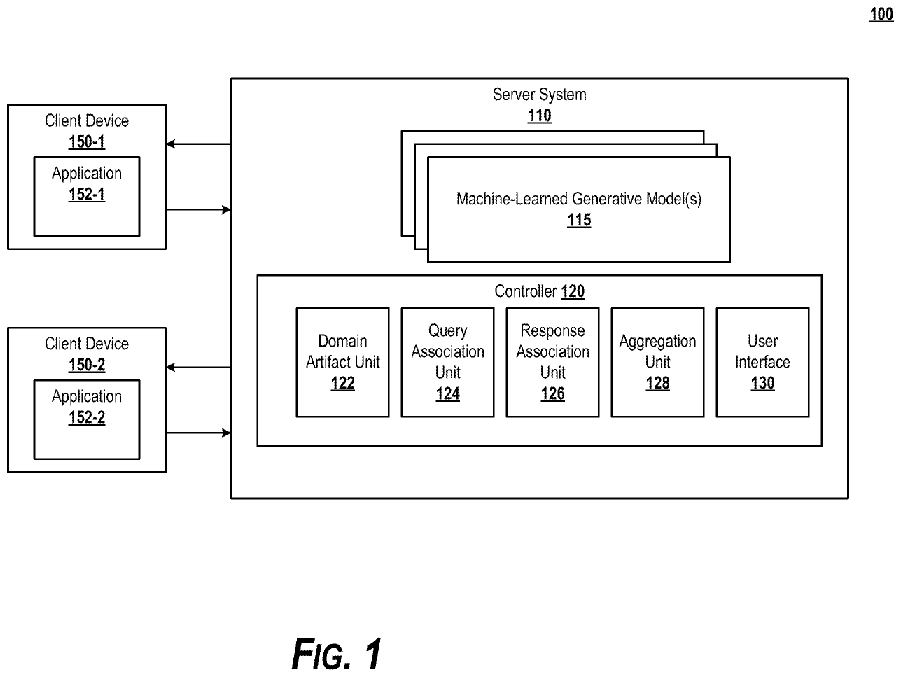

FIG. 1 is a block diagram depicting an example computing environment 100 in accordance with example embodiments of the present disclosure. Computing environment 100 includes a server system 110 that provides access to one or more machine-learned generative models 115 by users of client devices 150 via one or more networks (not shown). Computing environment 100 may include any number of client devices 150. Server system 110 hosts or otherwise implements one or more generative models 115. Server system 110 can implement any number of generative models 115.

In some examples, server system 110 may be implemented by a first computing system and each of the client devices 150 can be implemented by different remote computing systems. For instance, computing environment 100 may be implemented as a client server computing environment, including one or more client computing devices implementing downstream applications 152 and one or more server computing systems implementing server system 110. In another example, server system 110 can be accessed by one or more remote server systems in addition to or in place of client devices 150.

The computing systems implementing server system 110 and client devices 150 can be connected by and communicate through one or more networks (not shown). Any number of client computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a client computing device 150 implementing a downstream application 152 can be any suitable device, including, but not limited to, a smartphone, a tablet, a laptop, a desktop computer, or any other computer device that is configured such that it can allow a user to access remote computing devices over a network. The client computing devices can include one or more processor(s), memory, and a display as described in more detail hereinafter. The client computing devices can execute one or more client applications 152, such as a web browser, email application, chat application, video conferencing application, word processing application or the like. Applications 152 can access the machine-learned generative models 115 by passing user queries such as prompts or other inputs to the server system 110 for processing by the generative model.

The server system 110 can include one or more processor(s) and memory. The server computing system can be in communication with the one or more client computing device(s) using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium, such as RAM, hard disk, or optical or magnetic media.

In various examples, server system 110 can implement one or more cloud computing services, an email service, a videoconference service, or other hosted service that utilizes the server system 110 to store data, code, and the like that can be accessed by client devices. Server system 110 can implement one or more hosted applications that provide access to data stored in the storage domains.

Generative models 115 can include any type of machine-learned generative model. In an example, a generative model can include a sequence processing model, such as a large language model including 10B parameters or more. In another example, a generative model can include a language model having less than 10B parameters (e.g., 1B parameters). In yet another example, the generative model can include an autoregressive language model or an image diffusion model. As further examples, a generative model can include a machine-learned text-to-image model, a machine-learned text-to-video model, a machine-learned text-to-audio model, a machine-learned multi-modal model, or any other machine-learned model configured to provide generative content in response to a user query. The generative content generated by generative models 115 can include text data, image data, video data, audio data, or other types of generative content. The generative model can be trained to process input data to generate output data. The input data can include text data, image data, audio data, latent encoding data, and/or other input data, which may include multimodal data. The output data can include text data, image data, audio data, latent encoding data, and/or other input data.

In accordance with example embodiments of the present disclosure, server system 110 implements a controller 120 that is configured to moderate content sent to and produced by generative models 115-1, 115-2, . . . 115-n, and/or to generate outputs including visualizations of uses of the generative models, including inputs (e.g., prompts) to the model and outputs produced by the model as well as associated validity and risk. Controller 120 can include a domain artifact unit 122, a query association unit 124, a response association unit 126, an aggregation unit 128 and a user interface 130. Controller 120, domain artifact unit 122, query association unit 124, response association unit 126, and aggregation unit 128 can be implemented in hardware, software, or a combination of both hardware and software.

Controller 120 is configured to receive a user query, such as a prompt or other input that requests that one or more generative models 115 generate content, such as text, images, videos, audio, etc. in response to the user query. Controller 120 can pass the user query to one or more generative models 115 to produce generative content. In addition to standard processing of the user query to produce a response including generative content, controller 120 determines if the user query and/or the generative content produced by generative model(s) are valid for one or more target domains. For example, controller 120 can be configured to determine if a user prompt to a large language model and the textual content generated by the large language model are contextually relevant to a target textual domain. As another example, controller 120 can be configured to determine if a user's prompt to an image, audio, video generation or diffusion model and image, audio, video, content generated by the model are related to a target image, video, audio domain.

A domain can refer to a type, area, grouping, or other relation of content that shares one or more similarities with a particular knowledge area. A domain may be specified as content relating to a particular undertaking, business, study, etc. associated with a particular entity or enterprise. A target domain can be a particular content domain associated with an entity utilizing the generative model. For example, an entity may specify that one or more generative models are to be used for the business purposes of the entity, such as stock trading. In this instance, the entity may specify that a target domain is stock trading. The entity may have an expectation that users and applications accessing the generative model will be using the generative model to generate content related to stock trading, rather than things outside of the target domain (e.g., relating to credit cards, loans, mortgages, etc.). It will be appreciated that any type of domain can be used in accordance with embodiments of the present disclosure through the utilization of domain artifacts.

Controller 120 can be configured to moderate queries and/or responses based on their validity pertaining to a target domain. An entity may specify that queries and/or content unassociated with a target domain are to be moderated (e.g., blocked or filtered). Controller 120 can moderate invalid queries and content based on an entity's specified business logic. In some examples, controller 120 can return query and response validity information to an entity (e.g., an entity computing device) which can moderate the content based on its own implementation of business or other logic. Controller 120 can also be configured to generate outputs, such as visualizations of valid and invalid uses of the generative model(s) 115. For example, an entity may specify that information relating to uses outside of the target domain be surfaced, for example, through visualization(s) of the query and responses. The controller can record valid and invalid uses of the model and associate the corresponding data with the origin and intended destination.

Controller 120 includes a domain artifact unit 122 that includes information relating to one or more target domains. An entity can provide information, such as artifact data that includes information about a target domain. By way of example, domain artifact data may include keywords and terms for analyzing large language model usage relative to a target domain. In another example, domain artifact data may include representative images, audio, videos, etc. for a particular domain. The domain artifact unit 122 can store domain-specific data, such as vector embeddings of domain-specific information. The domain-specific data can be structured and/or unstructured data. The domain(s) in which an entity operates can be wide and include multiple dimensions. It is noted that an entity can include or specify multiple domains that can be relatively close to a target domain to provide comparative visualizations of model usage. In some examples as described hereinafter, the domain artifact unit can include a vector embedding database that stores vector embeddings of domain artifact data. Additionally or alternatively, the domain artifact unit can include a machine-learned domain classification model that is trained with domain artifact data.

Controller 120 includes a query association unit 124 that is configured to determine a query association of the user query with the target domain. Query association unit 124 can determine a query association by determining an association between a user query and domain artifacts for a target domain. In some examples, the query association unit can determine a distance between the user query and domain artifact data. For instance, the domain artifact data can be embedded into a vector embedding space and the vector embeddings stored in a vector embedding database. Query association unit 124 can embed the user query into the vector embedding space and determine a distance between the query embedding and the vector embeddings. By way of example, the query distance can be a semantic distance between the query embedding and the vector embeddings.

Query association unit 124 can also (or alternatively) provide the user query to a machine-learned classification model trained using the domain artifact data. The classification model can generate an output, such as a classification of whether the user query is associated with (e.g., relevant to and suitable for) the target domain. In some examples, the query association unit can generate a query association score based on the embedding comparison and/or the classification generated by the classification model. For instance, the score can represent the distance between embeddings and/or a probability that the query is associated with the target domain (e.g., as output by the classification model).

Controller 120 includes a response association unit 126 that is configured to determine a response association of the user query with the target domain. Similar to the query association unit 124, response association unit 126 can determine a response association by determining an association between the generative content generated by model(s) 115 in response to the user query and domain artifacts for the target domain. Response association unit 126 can determine a distance between the generative content and domain artifact data, using the vector embedding data for example. Response association unit 126 can embed the generative content into the vector embedding space and determine a distance between the content embedding and the vector embeddings. By way of example, the query distance can be a semantic distance between the content embedding and the vector embeddings.

The response association unit can also pass the generative content to the classification model to generate an output, such as a classification of whether the generative content is associated with the target domain. In some examples, the response association unit can generate a response association score based on the embedding comparison and/or the classification generated by the classification model. For instance, the score can represent the distance between embeddings and/or a probability that the generative content is associated with the target domain (e.g., as output by the classification model).

Aggregation unit 128 is configured to aggregate or otherwise combine the results of query association and response association processing and determination by controller 120. Query association unit 124 can pass the results of query association processing for each user query to aggregation unit 128. Similarly, response association unit 126 can pass the results of the response association processing for the generative content to aggregation unit 128.

Aggregation unit 128 can aggregate the query association data and the response association data for a query and response pair. The aggregation unit can also aggregate the results of the embedding score (e.g., the vector embedding output) and the results from the classification score (e.g., the domain-specific model output) and provide a visualization of the aggregation. The aggregation unit 128 can provide a collective score and/or compare scores to ensure the accuracy of both scores and that both scores are aligned. The aggregation unit 128 can also aggregate the results for similar prompts/responses from the same entity (e.g., client device 150 or application 152) to identify trends and enable the visualization of the identified trends. The aggregation unit output can be used by the controller 120 to determine whether to provide a response including the generative content or a response including filtered content. For example, aggregation unit 128 can compare the aggregated data with one or more association criteria to implement domain policies to filter queries and/or content that does not meet one or more requirements. The association criteria can include query association criteria and/or response association criteria. The association criteria can include combined criteria for the query association and response association in some examples. Additional criteria can also be used that are outside of associations. For example, malicious prompts, personal information in prompts or responses, etc. can be identified and moderated. The policies can be established by the controller and/or a downstream entity utilizing the model. The system can compare the query association and the response association with the association criteria, and if the association criteria are not satisfied, the system can filter the generative content from the response to the user query.

In some examples, the aggregation unit can generate a query association score for the target domain and compare it to a query association threshold. Similarly, the aggregation unit can generate a response association score for the target domain and compare it to a response association threshold. The query can be filtered if the query association score does not satisfy the one or more query association criteria and/or the generative content can be filtered if the response association score does not satisfy the one or more response association criteria. For example, the system may block generative content from being produced by the generative model if the query association score does not satisfy the query association criteria and/or may block generative content from being provided in response to the user query if the response association score does not satisfy the response association criteria. In some examples, the system can return the query association score and/or the response association score to the downstream entity which can implement its own logic to determine how to handle the query and response from the generative model.

Aggregation unit 128 can also aggregate the data to generate outputs, such as visualizations of the usage of the generative model(s) in relation to one or more target domains. For example, aggregation unit 128 can process the data to generate an output such as a visualization showing the distance (e.g., in embedding space) between the target domain(s) of a particular entity for both user queries and model responses. The generated data can be made available for an entity to consume. By way of example, controller 120 can include a user interface 130 that can generate data for visualizations of the distance using a dashboard or other visualization system. The information can provide a model for visualizing model or application usability and risk. Visualizations of inputs and outputs as well as their associated validity and risk relative to one or more domains can be provided. Outputs, such as visualizations of how different domains are used by generative models 115 and client devices 150 or applications 152 can assist entities with decision making, requirement satisfaction evaluations, and understanding of how users, such as customers of the entity use generative-model-based applications 152. The underlying data can provide an increased understanding of user behavior, risks, exposure of unwanted information and the like.

In example embodiments, aggregation unit 128 can obtain the data for multiple query/response pairs processed by the generative model(s). The results aggregator can perform a result aggregation process to aggregate the data for the multiple query/response pairs. In an example implementation, the results aggregator processes the data to determine the distance between the target content domain for both the query and response generated by the generative model(s).

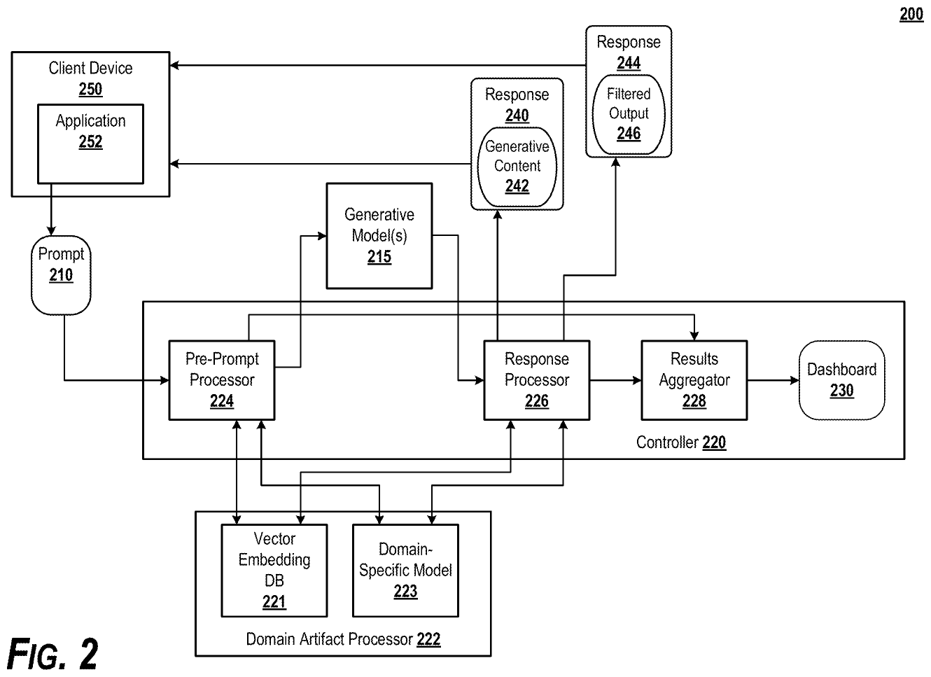

FIG. 2 is a block diagram depicting an example computing environment 200 and example data processing flow in accordance with example embodiments of the present disclosure. Computing environment includes a client device 250 having an application 252 that issues a prompt 210 or other user query requesting the generation of content by a machine-learned generative model 215. In other examples, prompt 210 may be issued by a user directly using client device 250. Prompt 210 is received by controller 220 which is configured to moderate the prompt 210 (including any input content) and content produced by generative model 215. Controller 220 is one example of a controller 120 depicted in FIG. 1. Controller 220 can analyze the prompt 210 and generative content 242 generated by generative model 215 to determine whether the prompt and generative content are valid for one or more target domains associated with a particular downstream entity, such as a business, school, university, governmental organization, or the like. For example, in response to prompt 210 and the resulting generative content 242, controller 220 can determine whether to generate and provide a response 240 including the generative content 242 or, alternatively, a response 244 including a filtered output 246. In some examples, controller 220 can block the prompt 210 from being executed by generative model(s) 215 or block any response from being provided to client device 250 or application 252 in response to prompt 210.

Controller 220 receives a prompt 210 or other user query which can include text data, image data, video data, audio data, sensor data, or any other data for processing by a generative model 215. As an example, a prompt may specify, “Please summarize this news article,” followed by the text or a pointer to the text of the article. As another example, a prompt may include a textual input and an image input depicting a horse on a cloudy day. The prompt may specify, “Make this <Image Input> look like it was a sunny day.”

Controller 220 receives the prompt 210 and provides it as an input to generative model 215. For example, controller 220 can prompt the generative model using prompt 210. In response to the user query, generative model 215 produces generative content 242.

Controller 220 also processes the prompt to determine a query association of the prompt with one or more target domains and a response association of generative content 240 with one or more target domains. Controller 220 can provide the prompt to a pre-prompt processor 224 which can determine a query association of prompt 210 relative to one or more target domains. Pre-prompt processor 224 can determine a query association for prompt 210 by passing the prompt or data associated with the prompt to a domain artifact processor 222. Domain artifact processor 222 can include a vector embedding database 221 and a domain-specific model 223, such as a large language model or other sequence processing model.

Vector embedding database 221 includes artifacts, datasets, or other information about a specific domain that are embedded into a vector embedding space. An entity can provide domain-specific data that is embedded into the vector embedding space by domain artifact processor 222 to generate vector embedding database 221. Vector embedding database 221 can include a plurality of vector embeddings generated from the domain-specific data. The vector embeddings can be multi-dimensional vector embeddings that capture the multiple-dimensional nature of entity- or domain-specific information. In some examples, the vector embedding database 221 can also include embeddings for domains that are close to the target domain.

Domain-specific model 223 can be a machine-learned sequence processing model, such as a text-based, image-based, video-based, audio-based, sensor data-based, or other type of classification model. In some examples model 223 can include a large language model that is trained using the domain-specific data. In some examples, model 223 is trained using only the domain-specific data for a target domain and optionally closely related domains. Model 223 can be trained to generate a binary output indicating whether a prompt input or generative model input is associated with a target domain. Model 223 can generate an output indicating a probability that a prompt or generative content is associated with one or more domains.

Pre-prompt processor 224 can embed prompt 210 into the vector embedding space and determine one or more query distances based on a distance between the prompt embedding and embeddings of the domain artifacts in the vector embedding database 221. Pre-prompt processor 224 can also pass prompt 210 to domain-specific model 223 which will generate an output indicative of whether the prompt is associated with the target domain. Pre-prompt processor 224 can determine whether a prompt is relevant to and suitable for the one or more domains on which the model was trained using the output of the domain-specific model 223. Pre-prompt processor 224 can determine whether prompt 210 is valid for the target domain based on the comparison to the embeddings in the vector embedding database 221 and/or the output of the domain-specific model 223. In some examples, pre-prompt processor 224 can generate a query association score based on the comparison with database 221 and/or the output of domain-specific model 223. Pre-prompt processor 224 can compare the score with one or more query association criteria, such as a threshold score, to determine if the prompt is valid for the target domain. Pre-prompt processor 224 also sends the results of processing the prompt 210 to results aggregator 228. Pre-prompt processor 224 can send the prompt, query association results, the results of comparison with database 221 and/or the output of domain-specific model 223.

Controller 220 determines a response association of the generative content 240 generated by generative model 215 using response processor 226. Response processor 226 accesses the generative content 240 generated by generative model 215 and passes the content to domain artifact processor 222. Response processor 226 can embed the generative content 240 into the vector embedding space and determine one or more query distances based on a distance between the content embedding and embeddings of the domain artifacts in the vector embedding database 221. Response processor 226 can also pass the content to domain-specific model 223 which will generate an output indicative of whether the content is associated with the target domain. Response processor 226 can provide generative content from generative model 215 as an input to domain-specific model 223. Domain-specific model 223 would be trained to determine if the generative content is relevant to and suitable for the one or more target domains on which the domain-specific model 223 was trained. Domain-specific model 223 can generate one or more outputs indicating whether the generative convent is valid for the target domain(s). Response processor 226 can determine whether generative content 240 is valid for the target domain based on the comparison to the embeddings in the vector embedding database 221 and/or the output of the domain-specific model 223. In some examples, response processor 226 can generate a response association score based on the comparison with database 221 and/or the output of domain-specific model 223. Response processor 226 can compare the score with one or more response association criteria, such as a threshold score to determine if the content is valid for the target domain. Response processor 226 also sends the results of processing the content 240 to results aggregator 228. Response processor 226 can send the content, response association results, the results of comparison with database 221 and/or the output of domain-specific model 223.

Results aggregator 228 can store and aggregate the results received from pre-prompt processor 224 and response processor 226. In some examples, aggregator 228 can aggregate the results of both prompt processing and response processing to determine whether to provide a response 240 including generative content 242 or a response 244 including a filtered output 246. For example, if the query association does not satisfy one more query association criteria, or if a response association does not satisfy one or more response association criteria, a response 244 including a filtered output 246 can be provided. If the query association satisfies the one more query association criteria and if the response association satisfies the one or more response association criteria, a response 240 including the generative content 242 can be provided.

Results aggregator 228 can also process the aggregated results data to generate one or more outputs, such as a dashboard 230 or other visualization. In an example implementation, the visualization can depict the distance between the target domain for both the prompt 210 and the generative content 240. Other visualizations of the input and/or output validity relative to one or more target domains can be provided. Dashboard 230 enables the results information to be made available to the downstream entity associated with the client device 250. The information in dashboard 230 or other visualization provides a model for measuring usability and risk associated with the generative model 215 relative to a target domain. In some examples, dashboard 230 and other visualizations can use logarithmic scaling depending on the proportional distance between different domains for improved readability.

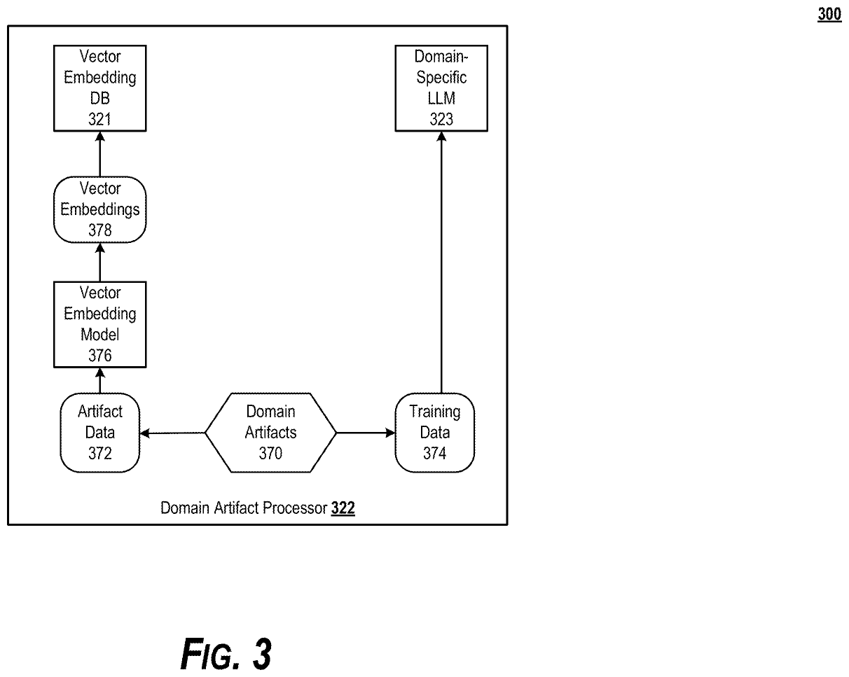

FIG. 3 is a block diagram depicting an example computing environment 300 including a domain artifact processor 322 in accordance with example embodiments of the present disclosure. Domain artifact processor 322 is one example of a domain artifact processor 222 as shown in FIG. 2. Domain artifact processor 322 stores or otherwise includes domain artifacts 370, such as data describing or associated with or more target domains. Domain artifacts 370 may include textual data, such as keywords or terms from a target domain, image data, such as representative images from the target domain, video data, such as representative video from the target domain, audio data, such as representative audio from the target domain, and the like.

The domain artifacts include artifact data 372 which is passed to vector embedding model 376. Vector embedding model 376 embeds the artifact data into a vector embedding space to generate vector embeddings 378. The vector embeddings 378 are then stored in vector embedding database 321. Vector embedding database 321 is one example of a vector embedding database 221 as shown in FIG. 2. The domain artifacts also include training data 374 that is used to train a machine-learning, domain-specific model 323. Domain-specific model 323 is one example of a domain-specific model 223 as shown in FIG. 2. Training data 374 can be the same data used for artifact data 372 or can be a different portion of the domain artifacts 370 than artifact data 372. Domain-specific model 323 can be a machine-learning, classification model, such as a large language model that is trained using the domain-specific training data 374. In some examples, model 323 is trained using only the domain-specific training data 374 for a target domain and optionally closely related domains.

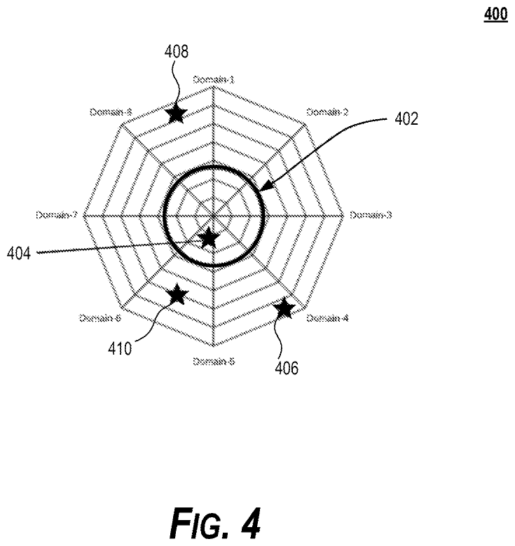

FIG. 4 depicts an example visualization 400 of query association and response association processing for an example query and response in accordance with an example embodiment of the present disclosure. Visualization 400 is one example of a dashboard 230 or other output that can be generated by results aggregator 228. Visualization 400 includes a spiderweb diagram that depicts nine domains and four example query/response results shown relative to the nine domains. A target entity domain 402 is represented by a circle encompassing an area around the center of the spiderweb. The other eight domains are represented as points at the outermost edges of the spiderweb. A first prompt/response pair 404 is depicted within the area of the target entity domain. The result of the prompt/response pair can be based on the prompt being inside the target domain, the response being inside the target domain, or both the prompt and response being inside the target domain. A second prompt/response pair 406 is depicted outside of the area of the target entity domain. The result of the prompt/response pair 406 can be based on the prompt being outside the target domain, the response being outside the target domain, or both the prompt and response being outside the target domain. Prompt/response pair 406 is closer to Domain-4. A third prompt/response pair 408 is depicted outside of the area of the target entity domain and closer to Domain-1 and Domain-8. A fourth prompt/response pair 410 is depicted outside of the area of the target entity domain and closer to Domain-6.

### Example Methods

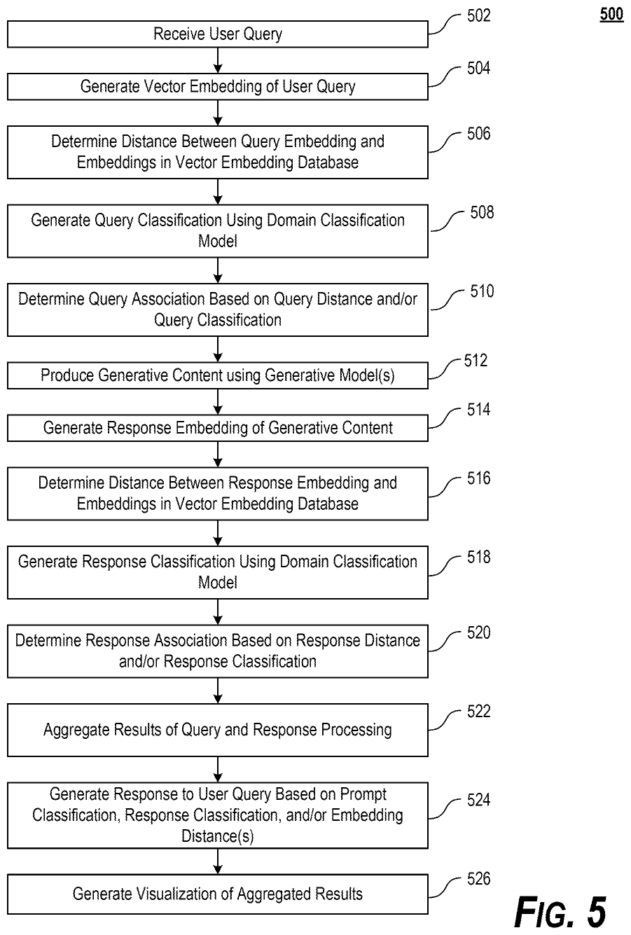

FIG. 5 is a flowchart diagram depicting an example method 500 for analyzing query processing by a system to determine the validity of query and responses relative to one or more target domains according to example embodiments of the present disclosure. One or more portion(s) of example method 500 and the other methods described herein can be implemented by a computing system that includes one or more computing devices, such as, for example, computing systems described with reference to FIG. 1, FIG. 2, and FIG. 3. By way of example, one or more portions of example method 500 can be performed by controller 120 or controller 220. Each respective portion of the example methods can be performed by any (or any combination) of one or more computing devices. Moreover, one or more portion(s) of the example method 500 can be implemented on the hardware components of the device(s) described herein, for example, to moderate content produced by one or more generative models. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and are not meant to be limiting. One or more portions of the example methods can be performed additionally, or alternatively, by other systems.

At 502, method 500 can include receiving a user query. In some examples, receiving a user query can include obtaining a user query. The user query can be received by a controller of a server system that is implemented in a cloud computing environment as indicated in the example embodiments. The user query can include one or more prompts which may include text data, audio data, video data, image data, and various combinations thereof.

At 504, method 500 can include generating one or more vector embeddings of the user query. The user query can be provided as an input to a machine-learned embedding model that is trained to embed the user query into a vector embedding space.

At 506, method 500 can include determining a distance between the query embedding and the embeddings in a domain-specific vector embedding database. The database can store the embeddings of domain artifacts of the target domain that have been embedded into the vector embedding space. In this manner at 506, method 500 can determine a distance of the query from the domain-specific data.

At 508, method 500 can include generating a query classification using a domain-specific model, such as a classification model trained using domain-specific data to generate an output indicating whether an input is relevant to and suitable for a target domain. The query can be passed as an input to the classification model which can generate a binary output, probability, or other indication of whether the user query is valid for the target domain.

At 510, method 500 can include determining a query association with the target domain based on the embedding distance and/or the output classification from the domain-specific model. The system can combine the query embedding distance determined from the vector embedding database and the query classification determined from the classification model to determine a query association with the target domain. Various techniques, such as weighting or otherwise can be used to determine a query association. In some examples, the query association can be a query association score that is based on both the embedding distance and the query classification.

In some examples, the system can determine if the query association indicates the user query should not be processed by the generative model(s). If the query association indicates the user query should not be processed, method 500 can include blocking the user query from being processed by the generative model(s). The system can generate a response with a filtered output or can block any response from being produced in response to the user query. In some examples, method 500 can conclude after determining the query association indicates the user query should not be processed.

At 512, method 500 can include producing generative content by inputting the user query into one or more machine-learned generative models. The generative model(s) can include a language model or large language model, a text-to-image or text-to-video model, a text-to-audio model, a multi-modal model, a sequence processing model, or any other machine-learned model trained to generate content in response to inputs. The generative content can include text data, audio data, image data, video data, or combinations thereof. In some examples, the system can be configured to only produce generative content after determining the query association satisfies one or more query association criteria. In other examples, the system can automatically produce generative content using the user query and then determine based on the query association and/or a response association whether to filter or block the generative content, for example.

At 514, method 500 can include generating one or more vector embeddings of the generative content produced by the generative model(s) in response to the user query. The generative content can be provided as an input to a machine-learned embedding model that is trained to embed the content into a vector embedding space.

At 516, method 500 can include determining a distance between the content embedding and the embeddings in the domain-specific vector embedding database. At 516, method 500 can determine a distance of the content from the domain-specific data.

At 518, method 500 can include generating a response classification using the domain-specific model trained using domain-specific data to generate an output indicating whether an input is relevant to and suitable for a target domain. The content can be passed as an input to the classification model which can generate a binary output, probability, or other indication of whether the content is valid for the target domain.

At 520, method 500 can include determining a response association with the target domain based on the embedding distance and/or the output classification from the domain-specific model. The system can combine the response embedding distance determined from the vector embedding database and the response classification determined from the classification model to determine a response association with the target domain. Various techniques, such as weighting or otherwise can be used to determine a response association. In some examples, the response association can include a response association score that is based on both the embedding distance and the query classification.

At 522, method 500 can include aggregating the results of processing the query and the generative content to determine validity relative to the target domain. The query association data and the response association data for a query and response pair can be aggregated to determine whether to provide a response including the generative content or a response including filtered content. The aggregated data can be compared with one or more association criteria which can include query association criteria and/or response association criteria. The policies can be established by a downstream entity utilizing the model. In some examples, the system can obtain the data for multiple query/response pairs and perform a result aggregation process to aggregate the data for the multiple query/response pairs.

At 524, method 500 can include generating a response to the user query based on the generative content as well as the query association and the response association. The system can compare the query association and the response association with the association criteria and if the association criteria are not satisfied, the system can filter the generative content from the response to the user query. If the association criteria are satisfied, the system can generate a response including the generative content. In some examples, the system can return the aggregated data to the downstream entity which can implement its own logic to determine how to handle the query and response from the generative model.

At 526, method 500 can include generating one or more visualizations of the aggregated results. The system can generate data for visualizations of the distance between queries/responses and a target domain using a dashboard or other visualization system. The aggregated results data can be used to generate one or more outputs, such as a dashboard or other visualization that depicts the distance between the target domain for both prompts and generative content.

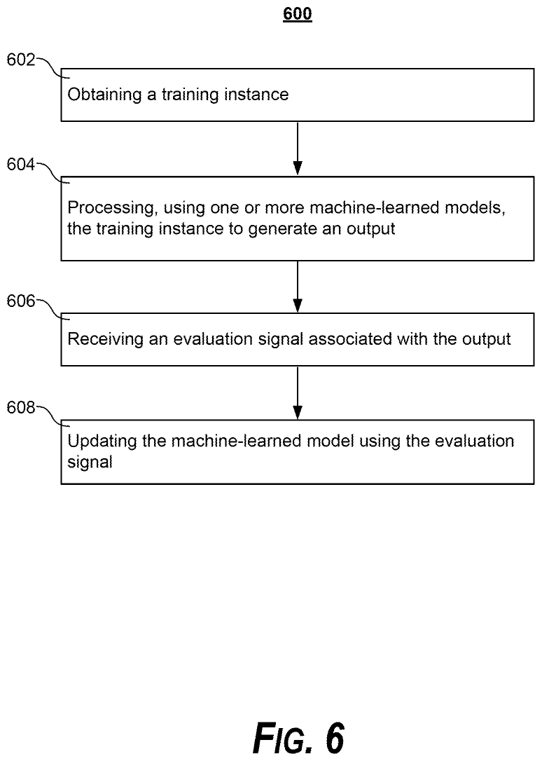

FIG. 6 depicts a flowchart of a method 600 for training one or more machine-learned models according to aspects of the present disclosure. For instance, an example machine-learned model can include a core sequence processing model, such as a foundational large language model (LLM).

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types. In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

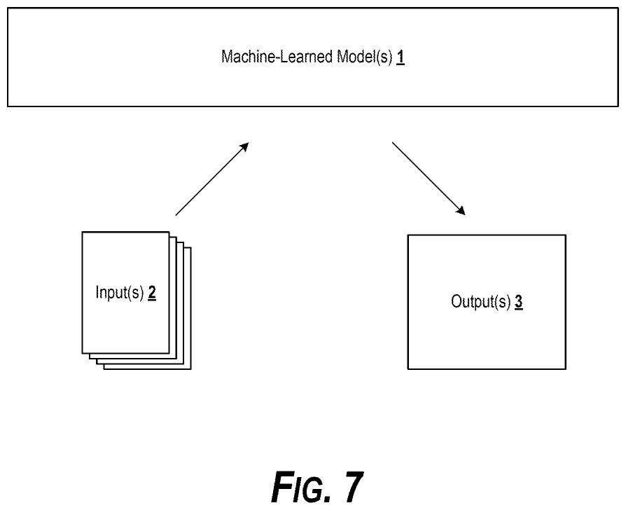

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism, such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

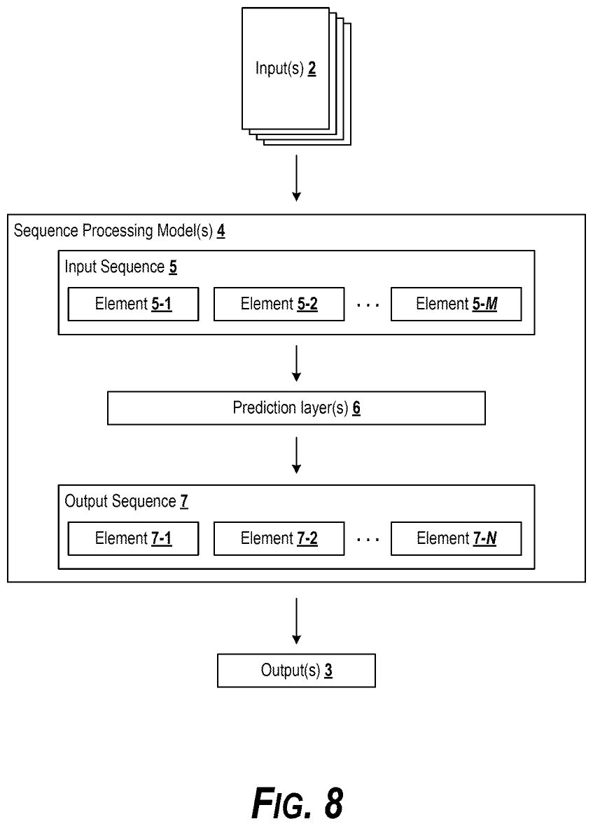

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

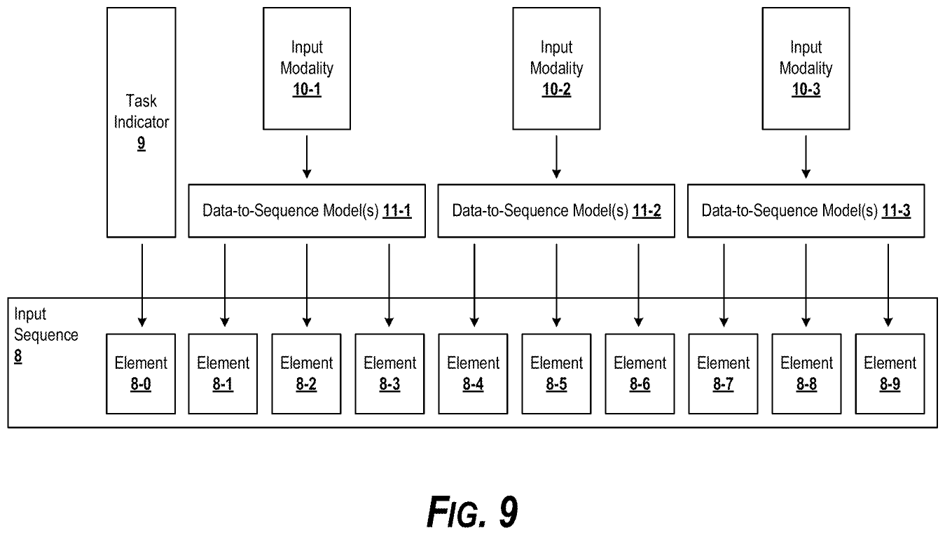

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

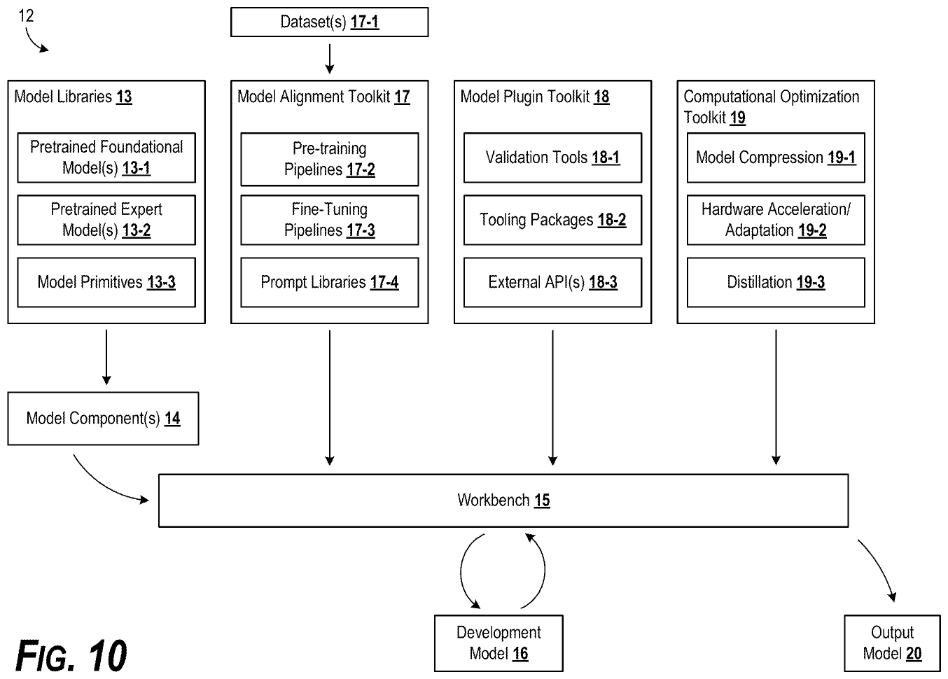

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

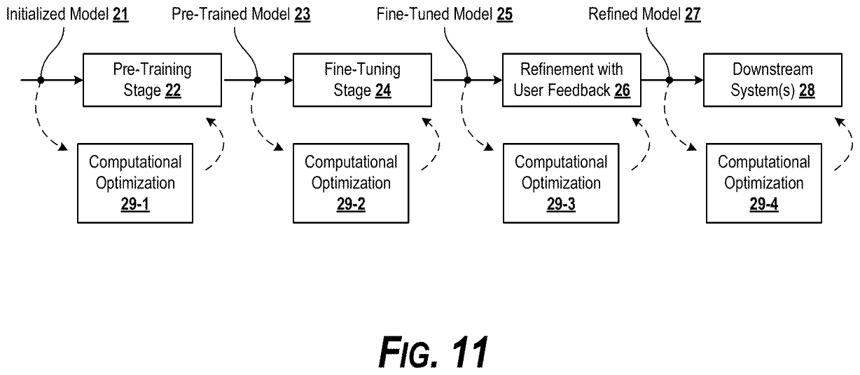

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

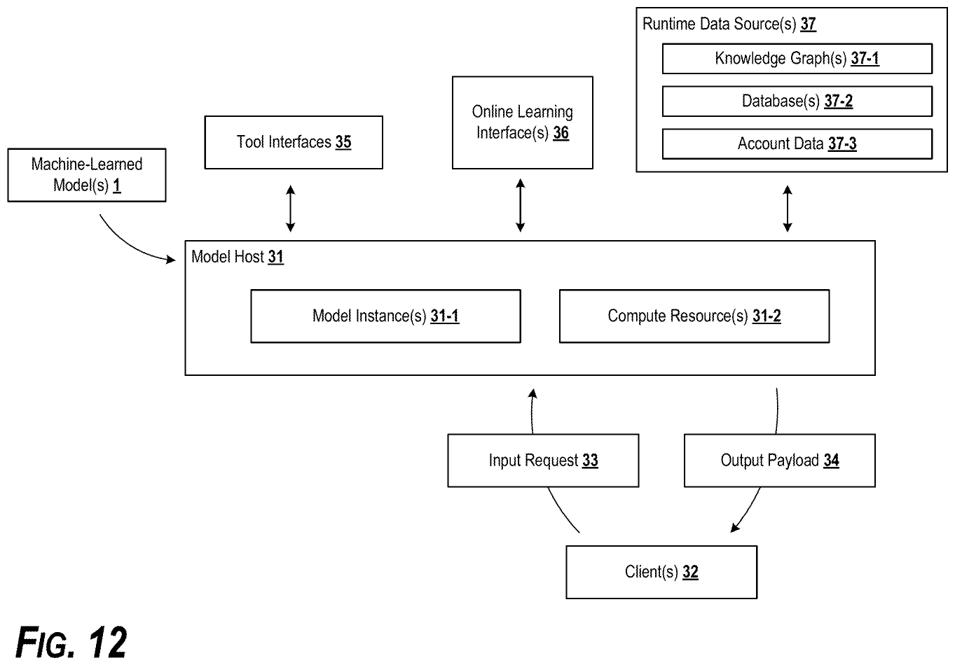

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

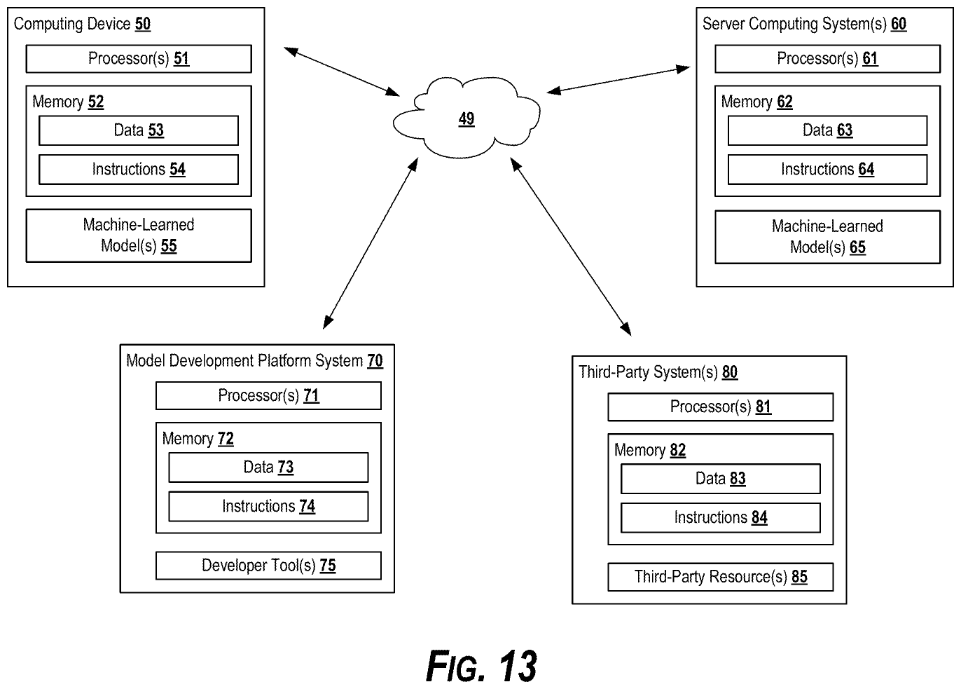

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

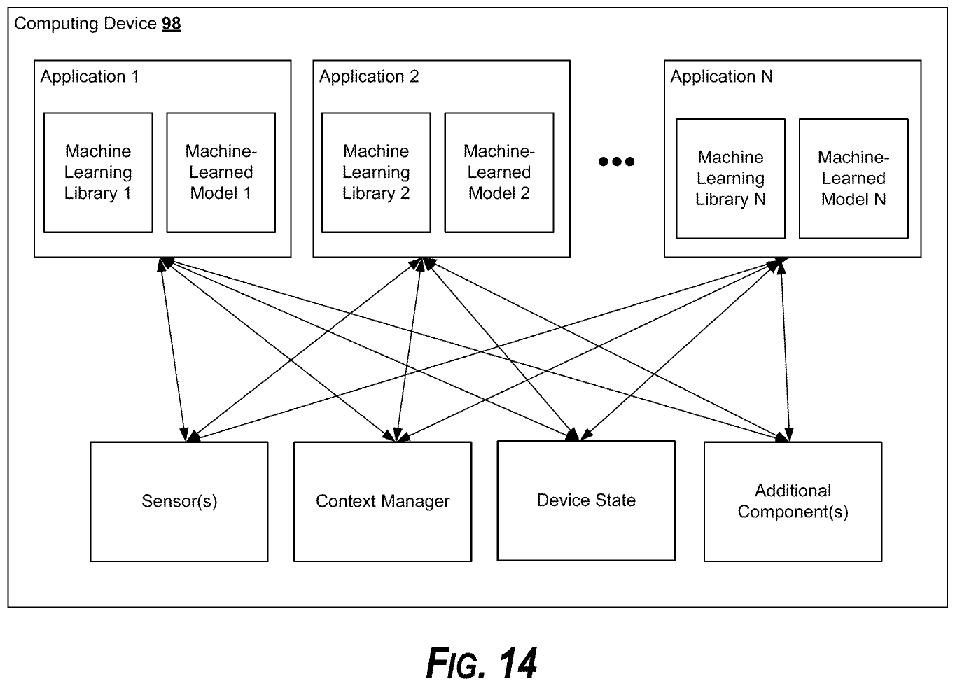

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

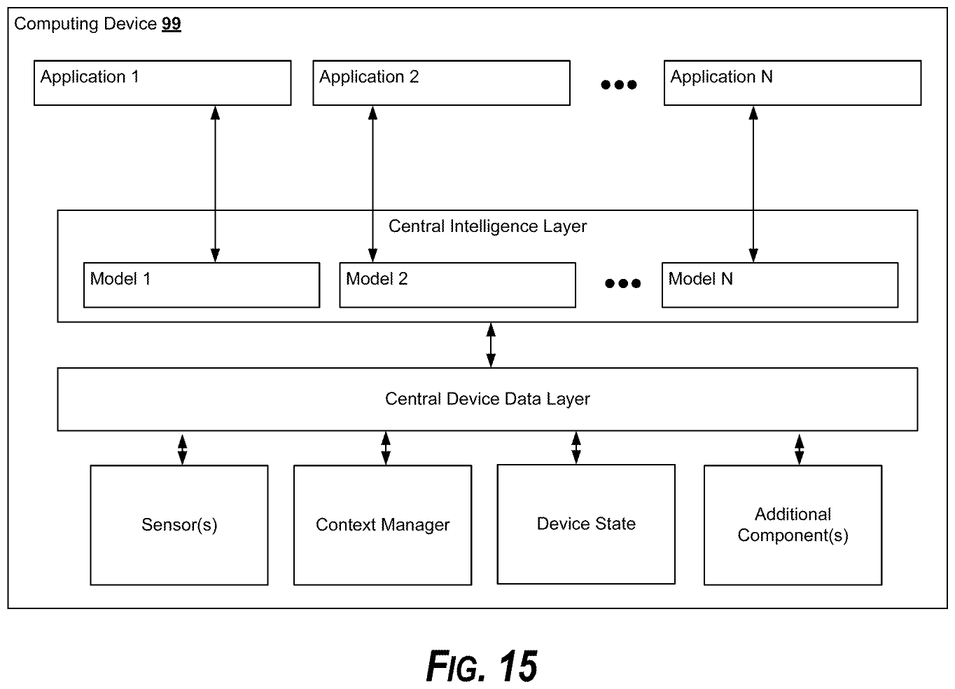

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
obtaining, by one or more processors, a user query requesting content generation by a machine-learned generative model;
producing, by one or more processors, generative content based on processing the user query with the machine-learned generative model;
generating, by one or more processors, data indicative of a query association with a target domain based on the user query and a plurality of domain artifacts associated with the target domain;
generating, by one or more processors, data indicative of a response association with the target domain based on the generative content and the plurality of domain artifacts associated with the target domain; and
generating, by one or more processors, a response to the user query based at least in part on the data indicative of the query association with the target domain and the data indicative of the response association with the target domain.

2. The computer-implemented method of claim 1, wherein generating, by the one or more processors, data indicative of the query association with the target domain, comprises:
determining, by one or more processors, a query distance based on comparing a vector embedding of the user query with a plurality of vector embeddings corresponding to the plurality of domain artifacts.

3. The computer-implemented method of claim 2, further comprising:
generating, by one or more processors, the vector embedding of the user query by embedding the user query into a vector embedding space using one or more machine-learned embedding models; and
generating, by one or more processors, the plurality of vector embeddings by embedding the plurality of domain artifacts into the vector embedding space using the one or more machine-learned embedding models.

4. The computer-implemented method of claim 3, wherein the query distance is a semantic distance between the vector embedding of the user query and the plurality of vector embeddings associated with the target domain.

5. The computer-implemented method of claim 1, wherein generating, by one or more processors, data indicative of the query association with the target domain, comprises:
generating, by one or more processors, a query classification by processing the user query with a machine-learned classification model that has been trained using the plurality of domain artifacts.

6. The computer-implemented method of claim 5, wherein the machine-learned classification model is a large language model.

7. The computer-implemented method of claim 5, further comprising:
providing, by one or more processors, at least a portion of the plurality of domain artifacts as training data to the machine-learned classification model; and
training, by one or more processors, the machine-learned classification model based at least in part on an output generated by the machine-learned classification model in response to the training data.

8. The computer-implemented method of claim 1, wherein generating, by one or more processors, data indicative of the query association with the target domain, comprises:
determining, by one or more processors, a query distance based on comparing a vector embedding of the user query with a plurality of vector embeddings corresponding to the plurality of domain artifacts; and
generating, by one or more processors, a query classification by processing the user query with a machine-learned classification model that has been trained using at least a portion of the plurality of domain artifacts.

9. The computer-implemented method of claim 1, wherein generating, by one or more processors, data indicative of the response association with the target domain, comprises:
determining, by one or more processors, a response distance based on comparing a vector embedding of the generative content with a plurality of vector embeddings associated with the target domain.

10. The computer-implemented method of claim 9, wherein the response distance is a semantic distance between the vector embedding of the generative content and the plurality of vector embeddings associated with the target domain.

11. The computer-implemented method of claim 9, wherein generating, by one or more processors, data indicative of the response association with the target domain, comprises:
generating, by one or more processors, a response classification by processing the user query with a machine-learned classification model that has been trained using at least a portion of the plurality of domain artifacts.

12. The computer-implemented method of claim 1, wherein generating, by one or more processors, data indicative of the response association with the target domain, comprises:
determining, by one or more processors, a response distance based on comparing a vector embedding of the generative content with a plurality of vector embeddings associated with the target domain; and
generating, by one or more processors, a response classification by processing the user query with a machine-learned classification model that has been trained using at least a portion of the plurality of domain artifacts.

13. The computer-implemented method of claim 1, further comprising:
comparing, by the one or more processors, the data indicative of the query association and the data indicative of the response association with one or more association criteria;
wherein generating the response to the user query comprises:
in response to the data indicative of the query association and the data indicative of the response association satisfying the one or more association criteria, providing the generative content in the response to the user query; and
in response to the data indicative of the query association and the data indicative of the response association not satisfying the one or more association criteria, filtering the generative content from the response to the user query.

14. The computer-implemented method of claim 1, further comprising:
obtaining, by the one or more processors, data indicative of a query association with the target domain for a plurality of user queries;
obtaining, by the one or more processors, data indicative of a response association with the target domain for a plurality of generative content generated by the machine-learned generative model in response to the plurality of user queries;
generating, by the one or more processors, aggregated results based on the data indicative of the query association with the target domain for the plurality of user queries and the data indicative of the response association with the target domain for the plurality of generative content; and
generating, by the one or more processors, a visualization of the aggregated results.

15. The computer-implemented method of claim 1, wherein:
the machine-learned generative model includes a large language model; and
the user query includes a prompt for the large language model.

16. The computer-implemented method of claim 1, wherein:
the machine-learned generative model includes an image generation model; and
the user query includes a prompt for the image generation model.

17. The computer-implemented method of claim 16, wherein:
the prompt includes image data.

18. A computing system, comprising:
one or more processors; and
one or more non-transitory computer-readable media that collectively store:
a machine-learned generative model configured to produce generative content in response to a user query; and
instructions that, when executed by the one or more processors, cause the one or more processors to perform operations, comprising:
obtain the generative content produced in response to the user query;
determine a query association with a target domain based on the user query and a plurality of domain artifacts associated with the target domain;
determine a response association with the target domain based on the generative content and the plurality of domain artifacts associated with the target domain; and
generate a response to the user query based at least in part on the query association with the target domain and the response association with the target domain.

19. The computing system of claim 18, wherein the one or more non-transitory computer-readable media collectively store:
a database comprising a plurality of vector embeddings corresponding to the plurality of domain artifacts; and
a machine-learned classification model that has been trained using the plurality of domain artifacts.

20. One or more non-transitory computer-readable storage media that store instructions that, when executed by one or more processors, cause the one or more processors to perform operations, the operations comprising:
obtaining a user query requesting content generation by a machine-learned generative model;
producing generative content based on processing the user query with the machine-learned generative model;
generating data indicative of a query association with a target domain based on the user query and a plurality of domain artifacts associated with the target domain;
generating data indicative of a response association with the target domain based on the generative content and the plurality of domain artifacts associated with the target domain; and
generating one or more outputs including an indication of the query association and an indication of the response association.
